(19) United States
(12) Patent Application Publication
(10) Pub. No.: US 2022/0311481 A1
(43) Pub. Date: Sep. 29, 2022

(54) ELECTRONIC GATEWAY DEVICE, SYSTEM, METHOD AND PROGRAM FOR PROMPTING CREATION OF HOTSPOT ON MOBILE DEVICE FOR CLIENT DEVICE

(71) Applicant: ARRIS Enterprises LLC, Suwanee, GA (US)

(72) Inventor: Xiangzhong JIAO, Shenzhen, Guangdong (CN)

(21) Appl. No.: 17/291,761

(22) PCT Filed: May 20, 2020
(86) PCT No.: PCT/CN2020/091371

§ 371 Date: May 6, 2021

(51) Int. Cl. H04B 7/0417; H04B 7/0426; H04W 48/02

(52) U.S. Cl. CPC H04B 7/0421; H04B 7/043; H04W 48/02

(57) ABSTRACT

An electronic gateway device includes a network interface configured to electronically wirelessly communicate with first and second client devices; a wide area network (WAN) interface configured to constructively communicate with an Internet; a memory having software stored thereon; and a processor configured to run the software to establish a service set identifier (SSID) for communication with the first and second client devices via the network interface; determine whether the electronic gateway device is presently able to connect to the Internet; upon a determination that the electronic gateway device is not able to connect to the Internet, send: (i) information identifying the SSID, and (ii) a creation request to the first client device to create a wireless hotspot network with the SSID for connection to the Internet; and send a steering instruction to the second client device for steering the second client device to the wireless hotspot network.

### TECHNICAL FIELD

The subject matter of the present disclosure relates generally to prompting the creation of a hotspot on a mobile device for a client device using a gateway/access point device.

### BACKGROUND

Popular electronic devices in many homes include mobile devices and client devices. Client devices may be smart media devices and/or smart appliances and may include customer-premises equipment (CPE). A single home may have multiple mobile and client devices which are associated or paired through a network such as a wired local area network (LAN), a wireless LAN (WLAN)(e.g., Wi-Fi), Bluetooth connectivity, etc.

Existing solutions connect via a gateway/access point device and cannot properly communicate if an Internet connection at the gateway/access point device is interrupted or lost (for example, due to a power outage). In such instances, the functionality of the existing solutions is substantially diminished. In other words, the reliability of the existing solutions is entirely dependent on the presence and strength of Internet connectivity at the gateway/access point device and the existing solutions can easily be compromised.

Thus, it would be advantageous and an improvement over the relevant technology to provide an electronic device, system, method, and program for prompting the creation of a hotspot on a mobile device for a client device.

### SUMMARY

An embodiment of the present disclosure provides an electronic device (e.g., gateway/access point device) for prompting the creation of a hotspot on a mobile device for a client device. The electronic gateway device comprises a network interface configured to electronically wirelessly communicate with a first client device and a second client device; a wide area network (WAN) interface configured to constructively communicate with the Internet; a memory having software stored thereon; and a processor configured to run the software to cause the electronic gateway device to execute at least the following: establish a service set identifier (SSID) for communication with the first client device and the second client device via the network interface; determine whether the WAN interface of the electronic gateway device is presently able to communicate with the Internet; upon a determination that the electronic gateway device is not able to communicate with the Internet, send: (i) information identifying the SSID, and (ii) a creation request to the first client device to create a wireless hotspot network with the SSID for connection to the Internet; and send a steering instruction to the second client device for steering the second client device to the wireless hotspot network of the first client device for connection to the Internet.

An embodiment of the present disclosure provides a method for prompting the creation of a hotspot on a mobile device for a client device. The method comprises establishing a service set identifier (SSID) for communication with a first client device and a second client device via a network interface of an electronic gateway device; determining whether the electronic gateway device is presently able to communicate with the Internet; upon a determination that the electronic gateway device is not able to communicate with the Internet, sending: (i) information identifying the SSID; and (ii) a creation request to the first client device to create a wireless hotspot network with the SSID for connection to the Internet; and sending a steering instruction to the second client device for steering the second client device to the wireless hotspot network of the first client device for connection to the Internet.

An embodiment described in the present disclosure provides a non-transitory computer-readable recording medium in an electronic device (e.g., gateway/access point device) for prompting the creation of a hotspot on a mobile device for a client device. The non-transitory computer-readable recording medium stores one or more programs which when executed by the hardware processor performs the steps of the methods described above.

### BRIEF DESCRIPTION OF THE DRAWINGS

In the drawings, like reference numbers generally indicate identical, functionally similar, and/or structurally similar elements.

FIG. 1 is a schematic diagram of a system for prompting the creation of a hotspot on a mobile device for a client device using a gateway/access point device according to an embodiment of the present disclosure;

FIG. 2 is a schematic diagram of a system according to an embodiment of the present disclosure;

FIG. 3 is a more detailed schematic diagram of a gateway/access point device, client device, and mobile device in the system for prompting the creation of a hotspot on a mobile device for a client device using a gateway/access point device according to an embodiment of the present disclosure; and

FIG. 4 illustrates a method and algorithm for prompting the creation of a hotspot on a mobile device for a client device using a gateway/access point device according to an embodiment of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded as merely examples. Accordingly, those of ordinary skill in the art will recognize that various changes and modifications of the examples described herein can be made without departing from the spirit and scope of the present disclosure. In addition, descriptions of well-known functions and constructions may be omitted for clarity and conciseness.

The terms and words used in the following description and claims are merely used to enable a clear and consistent understanding of the present disclosure. Accordingly, it should be apparent to those skilled in the art that the following description of the present disclosure is provided for illustration purposes only, and not for the purpose of limiting the present disclosure as defined by the appended claims and their equivalents.

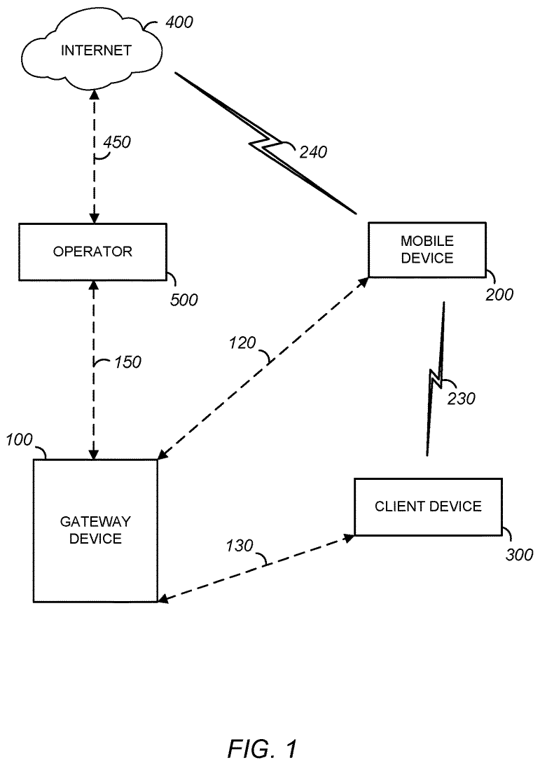

FIG. 1 is a schematic diagram of a system for prompting the creation of a hotspot on a mobile device for a client device using a gateway/access point device according to an embodiment of the present disclosure. As shown in FIG. 1, the system includes a gateway/access point device 100 normally connected to an operator 500 via a WAN connection 150 and also normally connected to a mobile device 200 via a connection 120 (e.g., a Wi-Fi connection) and a client device 300 via a connection 130 (e.g., a Wi-Fi connection). The WAN connection 150 constructively provides access to the Internet 400. Although FIG. 1 only shows one gateway/access point device 100, one mobile device 200 and one client device 300, any number of gateway/access point devices, any number of mobile devices and any number of client devices may be included. In FIG. 1, Internet connectivity is lost by the gateway/access point device 100 with the result that the client device 300 and the mobile device 200 lose Internet connectivity through Wi-Fi connections 120, 130 as well.

In FIG. 1, the operator 500 may include network equipment, (e.g., cable modem termination system, headend hardware, etc.), of a cable television provider, a satellite television provider, an Internet service provider (ISP), telco or multiple systems operator (MSO). The connection 450, the Internet 400, and the connection 150, between the operator 500 and the gateway/access point device 100 can be considered as encompassing and including any of a WAN, a virtual private network (VPN), metropolitan area networks (MANs), system area networks (SANs), a Data Over Cable Service Interface Specification (DOCSIS) network, a media over coax (MoCA) network, a fiber optics network (such as FTTH (fiber to the home) or FTTX (fiber to the x)), a hybrid fiber coaxial (HFC) network, a public switched data network (PSDN), a global Telex network, a digital subscriber line (DSL), or a wireless broadband system such as a 2G, 3G, 4G or 5G network, for example.

The gateway/access point device 100 is a hardware electronic device that acts as a router for providing content received from the operator 500 to network devices (e.g., mobile device 200, client device 300 or a wireless extender) in one of more wireless networks. It is also contemplated by the present disclosure that the gateway/access point device 100 can be, but is not limited to, an Internet Protocol/Quadrature Amplitude Modulator (IP/QAM) set-top box (STB) or smart media device (SMD) that is capable of decoding audio/video content, and playing over-the-top (OTT) or MSO provided content.

The mobile device 200 is a client device, for example, any handheld computer, smartphone, electronic tablet, e-reader, personal digital assistant (PDA), or portable music player with smart capabilities that is capable of connecting to the Internet over cellular networks, and interconnecting with other devices via Wi-Fi and Bluetooth protocols. The connection 120 between the gateway/access point device 100 and the mobile device 200 is implemented through a wireless connection that operates in accordance with, but is not limited to, any IEEE 802.11 protocol or Bluetooth protocol.

The client device 300 is, for example, any computer, appliance, smart speaker, Internet of Things (IoT) device, iControl device, or other wireless consumer electronic device capable of executing and displaying the content received through, for example, the gateway/access point device 100.

In FIG. 1, an Internet connection between the gateway/access point device 100 and the Internet is lost. A connection 240 between the mobile device 200 and the Internet 400 is implemented through a WAN connection. A connection 230 between the mobile device 200 and the client device 300 is implemented through a wireless connection that operates in accordance with, but is not limited to, any IEEE 802.11 protocol. In an exemplary implementation, the mobile device 200 establishes a WLAN for communication using, e.g., Wi-Fi, and allows not only the mobile device 200 to access the Internet 400, but also allows the client device 300 to access the Internet 400 via the WLAN established by the mobile device 200.

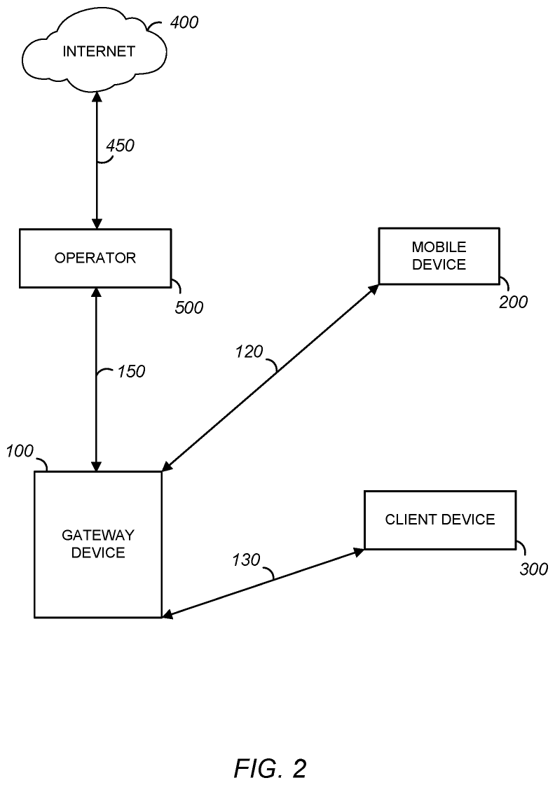

FIG. 2 is a schematic diagram of a system for prompting the creation of a hotspot on a mobile device (e.g., a first client device) for a client device (e.g., a second client device) using a gateway/access point device according to an embodiment of the present disclosure. As shown in FIG. 2, the system includes a gateway/access point device 100 connected to an operator 500 via a WAN connection 150 which constructively provides access to the Internet 400. The gateway/access point device 100 is also connected to a mobile device 200 and a client device 300.

In FIG. 2, a connection to the Internet 400 is provided by the gateway/access point device 100 to the client device 300. The connection 130 between the gateway/access point device 100 and the client device 300 is implemented through a wireless connection that operates in accordance with, but is not limited to, IEEE 802.11 protocol.

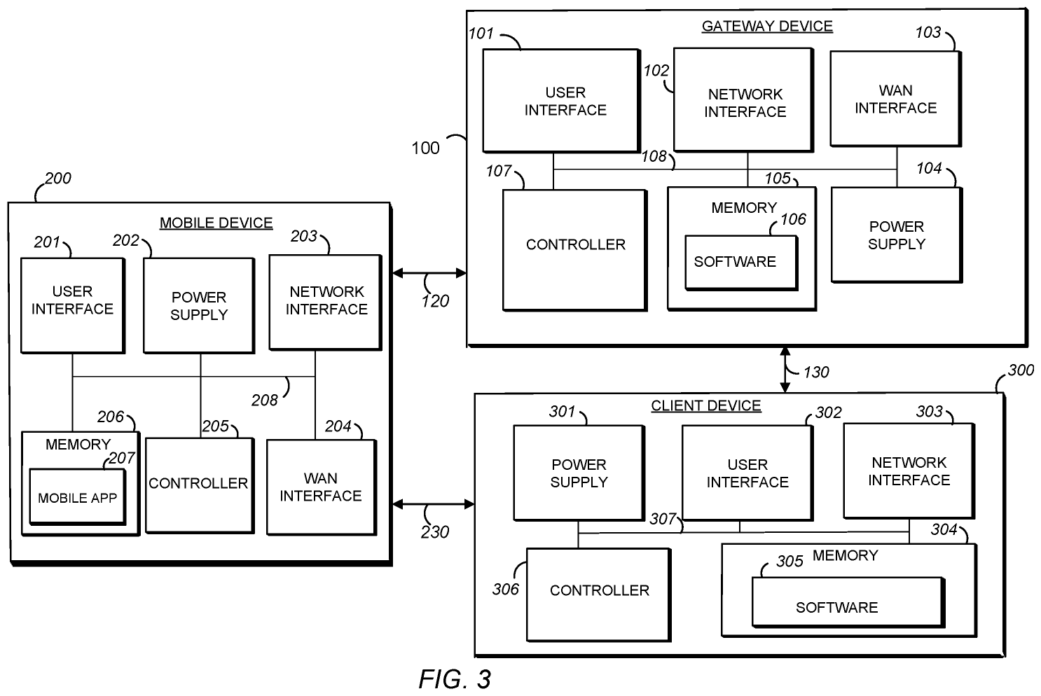

A detailed description of the exemplary internal components of the gateway/access point device 100, the mobile device 200, and the client device 300 shown in FIGS. 1 and 2 will be provided in the discussion of FIG. 3. However, in general, it is contemplated by the present disclosure that the gateway/access point device 100, the mobile device 200, and the client device 300 include electronic components or electronic computing devices operable to receive, transmit, process, store, and/or manage data and information associated with the system, which encompasses any suitable processing device adapted to perform computing tasks consistent with the execution of computer-readable instructions stored in a memory or a computer-readable recording medium.

Further, any, all, or some of the computing devices in the gateway/access point device 100, the mobile device 200, and the client device 300 may be adapted to execute any operating system, including Linux, UNIX, Windows, MacOS, DOS, and Chrome OS as well as virtual machines adapted to virtualize execution of a particular operating system, including customized and proprietary operating systems. The gateway/access point device 100, the mobile device 200, and the client device 300 are further equipped with components to facilitate communication with other computing devices over the one or more network connections to local and wide area networks, wireless and wired networks, public and private networks, and any other communication network enabling communication in the system.

FIG. 3 illustrates a more detailed schematic diagram of the gateway/access point device 100, the mobile device 200, and the client device 300 in the system for prompting the creation of a hotspot on a mobile device for a client device using a gateway/access point device according to an embodiment of the present disclosure.

Now referring to FIG. 3 (e.g., from left to right), the mobile device 200 is any handheld computer, smartphone, electronic tablet, e-reader, personal digital assistant (PDA), or portable music player with smart capabilities that is capable of connecting to the Internet over cellular networks, and interconnecting with other devices via Wi-Fi and Bluetooth. As shown in FIG. 3, an exemplary mobile device 200 may include a user interface 201, a power supply 202, a network interface 203, a WAN interface 204, a controller 205, and a memory 206. The user interface 201 includes, but is not limited to, push buttons, a keyboard, a keypad, a liquid crystal display (LCD), a cathode ray tube (CRT), a thin film transistor (TFT), a light-emitting diode (LED), and/or a high definition (HD) or other similar display device including a display device having touch screen capabilities so as to allow interaction between a user and the mobile device 200. The power supply 202 supplies power to the internal components of the mobile device 200 through an internal bus 208. The power supply 202 includes a self-contained power source such as a battery pack with an interface to be powered through an electrical charger connected to an outlet (e.g., either directly or by way of another device). The power supply 202 can also include a rechargeable battery that can be detached allowing for replacement such as a nickel-cadmium (NiCd), a nickel metal hydride (NiMH), a lithium-ion (Li-ion), or a lithium Polymer (Li-pol) battery.

The network interface 203 can include various network cards, interfaces, and circuitry implemented in software and/or hardware to enable communications with the gateway/access point device 100 using connection 120 as a wireless client or station or communications with the client device 300 using connection 230 as an access point. The various network cards, interfaces, and circuitry enable communications via connection 120 and/or communications via connection 230 using a wireless connection that operates in accordance with, but is not limited to, IEEE 802.11 protocol. The network interface can also provide a hotspot service by alternately configuring as an access point when the gateway device cannot provide a WLAN connection to the Internet.

The mobile device 200 is configured with a WAN interface 204 including Internet connection circuitry (via, e.g., a cellular network interface such as 2G, 3G, 4G, or 5G), allowing not only the mobile device 200 to access the Internet 400, but also allows other client devices (e.g., client device 300) to access the Internet 400 via the WLAN established by the network interface 203 of mobile device 200 and via the WAN interface 204 of the mobile device 200.

The memory 206 includes a single memory or one or more memories or memory locations that include, but are not limited to, random access memory (RAM), dynamic random access memory (DRAM), a memory buffer, a hard drive, a database, an erasable programmable read only memory (EPROM), an electrically erasable programmable read only memory (EEPROM), read only memory (ROM), flash memory, logic blocks of a field programmable gate array (FPGA), a hard disk or any other various layers of memory hierarchy.

The memory 206 can be used to store any type of instructions including software such as a mobile application 207 associated with algorithms, processes, or operations for controlling the general functions and operations of the mobile device 200 and the creation and/or disabling of a hotspot for the client device 300. The mobile application 207 can be written by the manufacturer of the gateway/access point device 100 and installed in the mobile device 200 by the user.

The controller 205 controls the general operations of the mobile device 200 and includes, but is not limited to, a central processing unit (CPU), a hardware processor such as, a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and performing the functions of the mobile device 200. General communication between the components (e.g., 201-206) of the mobile device 200 may be performed using an internal bus 208.

The gateway/access point device 100 is a hardware electronic device that acts as a router for providing content received from a WAN interface 103 to the devices (e.g., mobile device 200 and client device 300) in a wireless network using one or more of connections 120, 130. As shown in FIG. 3, the gateway/access point device 100 includes a user interface 101, a network interface 102, the WAN interface 103, a power supply 104, a memory 105, and a controller 107.

The network interface 102 may include various network cards, and circuitry implemented in software and/or hardware to enable communications with the mobile devices 200 using connection 120 and with the client device 300 using connection 130. The various network cards, interfaces, and circuitry of the network interface 102 enable communications via connection 120 to the mobile device 200 using a wireless protocol that operates in accordance with, but is not limited to, any IEEE 802.11 protocol.

The WAN interface 103 may include various network cards, and circuitry implemented in software and/or hardware to enable communications with operator network 150 (not shown). The various network cards, interfaces, and circuitry of the network interface 102 enable communications to be routed from network interfaces 203 and 303 to the Internet via WAN interface 103.

The memory 105 includes a single memory or one or more memories or memory locations that include, but are not limited to, RAM, DRAM, a memory buffer, a hard drive, a database, an EPROM, an EEPROM, ROM, flash memory, logic blocks of a FPGA, a hard disk or any other various layers of memory hierarchy. The memory 105 can be used to store any type of instructions including software 106 associated with algorithms, processes, or operations for controlling the general functions and operations of the gateway/access point device 100 for prompting the creation and/or disabling of a hotspot for the client device 300.

The controller 107 controls the general operations of the gateway/access point device 100 and includes, but is not limited to, a CPU, a hardware processor such as a microprocessor, a multi-core processor, a single core processor, a FPGA, a microcontroller, an ASIC, a DSP, or other similar processing device capable of executing any type of instructions, algorithms, or software for controlling the operation and performing the functions of the gateway/access point device 100. Communication between the components (e.g., 101-105 and 107) of the gateway/access point device 100 may be established using an internal bus 108.

The client device 300 includes, for example, a smart phone, a computer, an appliance (e.g., smart refrigerator, smart air conditioner, smart television or smart light), a smart speaker (e.g., Google Home or Amazon Echo), an IoT device, an iControl device, or other wireless consumer electronic device capable of executing and displaying the content received through the gateway/access point device 100. As shown in FIG. 3, the client device 300 includes a power supply 301, a user interface 302, a network interface 303, a memory 304, and a controller 306. The power supply 301 supplies power to the internal components of the client device 300 through an internal bus 307. The power supply 301 can be a self-contained power source such as a battery pack with an interface to be powered through an electrical charger connected to an outlet (e.g., either directly or by way of another device).

The network interface 303 may include various network cards, interfaces, and circuitry implemented in software and/or hardware to enable communications with the gateway/access point device 100 via connection 130 (or the mobile device 200 via connection 230) using a wireless protocol.

Additionally, the various network cards, interfaces, and circuitry of the network interface 303 enable communications via connections 130, 230 using a wireless connection that operates in accordance with, but is not limited to, IEEE 802.11 protocol, RF4CE protocol, ZigBee protocol, Z-Wave protocol, or IEEE 802.15.4 protocol.

The memory 304 includes a single memory or one or more memories or memory locations that include, but are not limited to RAM, DRAM, a memory buffer, a hard drive, a database, an EPROM, an EEPROM, ROM, flash memory, logic blocks of a FPGA, a hard disk or any other various layers of memory hierarchy. The memory 304 can be used to store any type of instructions including software 305 associated with algorithms, processes, or operations for controlling the general functions and operations of the client device 300 and connecting to a hotspot created by the mobile device 200.

The controller 306 controls the general operations of the client device 300 and includes, but is not limited to, a CPU, a hardware processor such as a microprocessor, a multi-core processor, a single core processor, a FPGA, a microcontroller, an ASIC, a DSP, or other similar processing device capable of executing any type of instructions, algorithms, or software for controlling the operation and performing the functions of the client device 300. Communication between the components (e.g., 301-304 and 306) of the client device 300 may be established using an internal bus 307.

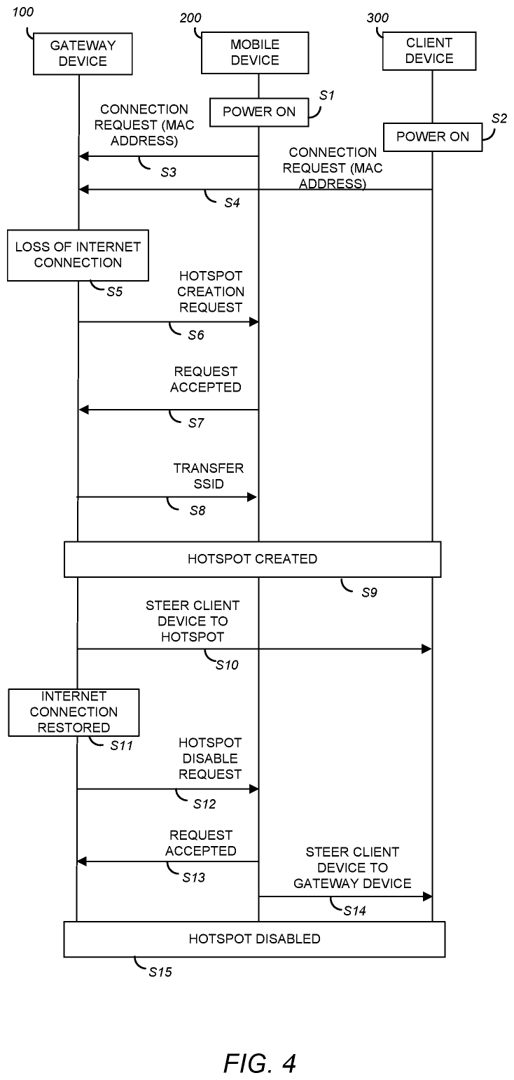

FIG. 4 illustrates an exemplary method and algorithm for prompting the creation and/or disabling of a hotspot for the client device 300 according to an embodiment of the present disclosure. It is assumed that the gateway/access point device 100, the mobile device 200 and the client device 300 include their respective software 106, 207, 305 in their respective memories 105, 206, 304. In FIG. 4, the method and algorithm illustrate operations performed by processors running the software 106 of the gateway/access point device 100, the software 207 of the mobile device 200 and the software 305 of the client device 200 prompting the creation and/or disabling of a hotspot for the client device 300. The software 106, 207, 305 in the respective memories 105, 206, 304 can be for implementing, for example, a procedure between the gateway/access point device 100 and the mobile device 200 for establishing a connection 230 between the mobile device 200 and the client device 300. Although FIG. 4 shows one gateway/access point device 100, one mobile device 200 and one client device 300, it is contemplated by the present disclosure that the method and algorithm can be applied to any number of gateway/access point devices 100, mobile devices 200 and client devices 300 for prompting the creation and/or disabling of a hotspot for the client device 300 described with reference to FIG. 1.

The mobile application 207 can be installed in the mobile device 200 by the user and the user can determine whether to activate “Backup Internet” service. Accordingly, the mobile device 200 can provide a hotspot service for the client device 300 only when necessary.

In Steps S1 and S2, the mobile device 200 and the client devices 300 are turned on by using their respective power supplies 202, 301 and in Step S3, the mobile device 200 transmits a request (e.g., including a respective Media Access Control (MAC) address) to the gateway/access point device 100 for connection to a network. The request can be invoked by, for example, pressing a physical or touchscreen button on the user interface 201 of the mobile device 200 and transmitting the request via connection 120.

In Step S4, the client device 300 transmits a request (e.g., including a respective MAC address) to the gateway/access point device 100 for connection to a network. The request can be invoked by, for example, pressing a physical or touchscreen button on the user interface 302 of the client device 300 and transmitting the request via connection 130. It is contemplated by the present disclosure that the requests for connection to the network can be transmitted from the mobile device 200 and the client device 300 either simultaneously or sequentially, but the requests will generally be processed by the gateway/access point device 100 sequentially. The gateway/access point device 100 may compile a candidate list of the MAC addresses of the devices 200, 300. The user can edit the candidate list by selecting which devices are included or omitted from the candidate list. The gateway/access point device 100 may transmit responses for establishing network connections with the mobile device 200 and the client device 300, respectively. Each response may include, for example, an SSID established by the gateway/access point device 100 and part or all of the MAC address or serial number of the device transmitting the request (e.g., mobile device 200 transmitting the request in Step S3 or client device 300 transmitting the request in Step S4).

In Step S5, the loss of Internet connectivity is detected at the gateway/access point device 100. The controller 107 can check the WAN connection by periodically sending a ping to one or more specified addresses or by periodically sending a Domain Name System (DNS) Query to a DNS server. If the ping or DNS Query fails repeatedly over a period of time (for example, one minute, ten minutes, etc.), a loss of Internet connectivity is detected. In other words, it is determined that the gateway/access point device 100 cannot communicate with servers reachable over the Internet.

In Step S6, the gateway/access point device 100 checks if the mobile device 200 (i.e., the device for which “Backup Internet” service has been activated) is connected to the gateway/access point device 100 and if so, sends a creation request to the mobile device 200 to create a hotspot for the client device 300. If the mobile device 200 is not connected to the gateway/access point device 100, the process ends. The creation request may include a push notification in the mobile application 207 of the mobile device 200. For example, the gateway/access point device 100 could send a message to the mobile device 200 and the mobile device 200 could pop up a notification in the mobile application 207 such as “Wi-Fi router is out of service, would you like to open a hotspot on your smartphone to provide Internet service for smart devices?”

In Step S7, the user of the mobile device 200 accepts the creation request (for example, by clicking “YES” on the mobile application 207 running on the mobile device 200). In Step S8, a network or Wi-Fi setting of the gateway/access point device 100 is sent from the gateway/access point device 100 to the mobile device 200 and copied by the mobile device 200. The network setting may include at least one of the SSID established by the gateway/access point device 100, security information or a password. The network setting copying can be enabled on the 2.4 GHz band for better compatibility. If, however, the user declines the creation request (for example, by clicking “NO” on the mobile application 207 running on the mobile device 200), the process ends. In Step S9, the mobile device 200 creates the hotspot. In some variations, the mobile device 200 may also limit the amount of bandwidth allocated to the hotspot to prevent the mobile device 200 from exceeding a data usage limit or byte cap.

In Step S10, the gateway/access point device 100 steers the client device 300 to the mobile device 200 and stops providing Wi-Fi service itself. The steering can be based on the candidate list of MAC addresses. For example, if video streams for a smart television would require too much data and would result in the mobile device 200 exceeding a data usage limit or byte cap, the user can omit the smart television from the candidate list. Only devices included in the candidate list may be allowed to connect to the hotspot. For example, the controller 107 could suppress probe response messages from the gateway/access point device 100 to the client device 300, decline association with the client device 300, and/or dissociate the client device 300 from the gateway/access point device 100. Accordingly, the gateway/access point device 100 can guide the client device 300 to perform a handshake (i.e., establish a network connection) with the mobile device 200.

In Step S11, the Internet connection is restored at the gateway/access point device 100 and the gateway/access point device 100 turns on Wi-Fi service.

In Step S12, the gateway/access point device 100 sends a disable request to the mobile device 200 to disable the hotspot. For example, when the Internet connection is restored, the mode of the gateway/access point device 100 can be changed from an access point (AP) mode in which the gateway/access point device 100 creates its own wireless (e.g., Wi-Fi) network to a station (STA) mode in which the gateway/access point device 100 can connect to a wireless (e.g., Wi-Fi) network created by another device. In STA mode, the gateway/access point device 100 may connect to the hotspot created by the mobile device 200. The gateway/access point device 100 could then send a message to the mobile device 200 via the hotspot and the mobile device 200 could pop up a notification in the mobile application 207 such as “Wi-Fi router is back in service, would you like to disable the hotspot?”

In Step S13, the user of the mobile device 200 accepts the disable request (by using the mobile application 207). If, however, the user initially declines the disable request (by using the mobile application 207), additional disable requests may be sent periodically thereafter. After receiving a reply from the mobile device 200 via the hotspot, the mode of the gateway/access point device 100 can be changed back to AP mode.

In Step S14, the mobile device 200 steers the client device 300 to the gateway/access point device 100. For example, the controller 205 could suppress probe response messages from the mobile device 200 to the client device 300, decline association with the client device 300, and/or dissociate the client device 300 from the mobile device 200. Accordingly, the mobile device 200 can guide the client device 300 to perform a handshake (i.e., establish a network connection) with the gateway/access point device 100.

In Step S15, the mobile device 200 disables the hotspot and the process ends.

In the exemplary method and algorithm of FIG. 4, the prompting of the creation and disabling of the hotspot is performed automatically by the gateway/access point device 100. Furthermore, the creation and disabling of the hotspot may be accepted by the user directly from the mobile device 200 by using the mobile application 207 via connection 120 or the user may configure the mobile device via the app to perform the creation and disabling of the hotspot automatically when the GW reports a loss of Internet access. By using the method and algorithm of FIG. 4, an auxiliary Internet connection can be provided by tethering or phone-as-modem (PAM) for any number of wireless smart devices (e.g., client device 300).

The present disclosure may be implemented as any combination of an apparatus, a system, an integrated circuit, and a computer program on a non-transitory computer readable recording medium. The one or more processors may be implemented as an integrated circuit (IC), an application specific integrated circuit (ASIC), or large scale integrated circuit (LSI), system LSI, super LSI, or ultra LSI components that perform a part or all of the functions described in the present disclosure.

The present disclosure includes the use of software, applications, computer programs, or algorithms. The software, applications, computer programs, or algorithms can be stored on a non-transitory computer-readable medium for causing a computer, such as the one or more processors, to execute the steps described in FIG. 4. For example, the one or more memories store software or algorithms with executable instructions and the one or more processors can execute a set of instructions of the software or algorithms in association with prompting the creation of a hotspot on a mobile device for a client device using a gateway/access point device.

The software and computer programs, which can also be referred to as programs, software applications, applications, components, or code, include machine instructions for a programmable processor, and can be implemented in a high-level procedural language, an object-oriented programming language, a functional programming language, a logical programming language, or an assembly language or machine language. The term computer-readable recording medium refers to any computer program product, apparatus or device, such as a magnetic disk, optical disk, solid-state storage device, memory, and programmable logic devices (PLDs), used to provide machine instructions or data to a programmable data processor, including a computer-readable recording medium that receives machine instructions as a computer-readable signal.

By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Use of the phrases “capable of,” “capable to,” “operable to,” or “configured to” in one or more embodiments, refers to some apparatus, logic, hardware, and/or element designed in such a way to enable use of the apparatus, logic, hardware, and/or element in a specified manner. The subject matter of the present disclosure is provided as examples of apparatus, systems, methods, and programs for performing the features described in the present disclosure. However, further features or variations are contemplated in addition to the features described above. It is contemplated that the implementation of the components and functions of the present disclosure can be done with any newly arising technology that may replace any of the above implemented technologies.

Additionally, the above description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, features described with respect to certain embodiments may be combined in other embodiments.

We claim:

1. An electronic gateway device comprising:
a network interface configured to electronically wirelessly communicate with a first client device and a second client device;
a wide area network (WAN) interface configured to constructively communicate with an Internet;
a memory having software stored thereon; and
a processor configured to run the software to cause the electronic gateway device to execute at least the following:
establish a service set identifier (SSID) for communication with the first client device and the second client device via the network interface;
determine whether the electronic gateway device is presently able to communicate with the Internet;
upon a determination that the electronic gateway device is not able to communicate with the Internet, send: (i) information identifying the SSID, and (ii) a creation request to the first client device to create a wireless hotspot network with the SSID; and
send a steering instruction to the second client device for steering the second client device to the wireless hotspot network of the first client device.

2. The electronic gateway device of claim 1, wherein the determination that the electronic gateway device is not able to communicate with the Internet is made if the WAN interface cannot establish constructive communication with the Internet in any of multiple attempts over a period of time.

3. The electronic gateway device of claim 2, wherein the period of time is ten minutes.

4. The electronic gateway device of claim 1, wherein the creation request includes a push notification.

5. The electronic gateway device of claim 1, wherein the processor is further configured to run the software to cause the electronic gateway device to, upon a determination that the electronic gateway device is presently able to communicate with the Internet, send a disable request to the first client device to disable the wireless hotspot network.

6. The electronic gateway device of claim 1, wherein the steering instruction is based on a candidate list of Media Access Control (MAC) addresses.

7. The electronic gateway device of claim 6, wherein the candidate list of MAC addresses is editable by a user.

8. A system comprising:
the electronic gateway device of claim 1; and
the first client device.

9. The system of claim 8, wherein the first client device comprises:
a memory having software stored thereon; and
a processor configured to run the software of the first client device to cause the first client device to execute at least the following:
create the wireless hotspot network; and
send a steering instruction to the second client device for steering the second client device to the electronic gateway device for connection to the Internet.

10. The system of claim 8, wherein the first client device comprises:
a memory having software stored thereon; and
a processor configured to run the software of the first client device to cause the first client device to execute at least the following:
create the wireless hotspot network; and
limit bandwidth allocated to the wireless hotspot network.

11. A method implemented on an electronic gateway device, the method comprising:
establishing a service set identifier (SSID) for communication with a first client device and a second client device via a network interface of the electronic gateway device;
determining whether the electronic gateway device is presently able to communicate with an Internet;
upon a determination that the electronic gateway device is not able to communicate with the Internet, sending: (i) information identifying the SSID; and (ii) a creation request to the first client device to create a wireless hotspot network with the SSID; and
sending a steering instruction to the second client device for steering the second client device to the wireless hotspot network of the first client device.

12. The method of claim 11, wherein the determination that the electronic gateway device is not able to communicate with the Internet is made if a WAN interface of the electronic gateway device cannot establish constructive communication with the Internet in any of multiple attempts over a period of time.

13. The method of claim 12, wherein the period of time is ten minutes.

14. The method of claim 11, wherein the creation request includes a push notification.

15. The method of claim 11, further comprising, upon a determination that the electronic gateway device is presently able to communicate with the Internet, sending a disable request to the first client device to disable the wireless hotspot network.

16. The method of claim 11, wherein the steering instruction is based on a candidate list of Media Access Control (MAC) addresses.

17. The method of claim 16, wherein the candidate list of MAC addresses is editable by a user.

18. The method of claim 11, further comprising sending a steering instruction to the second client device for steering the second client device to the electronic gateway device.

19. The method of claim 11, further comprising limiting bandwidth allocated to the wireless hotspot network.

20. A non-transitory computer readable recording medium having stored thereon a program implemented on an electronic gateway device, the program causing the electronic gateway device to perform steps comprising:
establishing a service set identifier (SSID) for communication with a first client device and a second client device via a network interface of the electronic gateway device;
determining whether the electronic gateway device is presently able to communicate with an Internet;
upon a determination that the electronic gateway device is not able to communicate with the Internet, sending: (i) information identifying the SSID; and (ii) a creation request to the first client device to create a wireless hotspot network with the SSID; and
sending a steering instruction to the second client device for steering the second client device to the wireless hotspot network of the first client device
